(19) United States
(12) Patent Application Publication
(10) Pub. No.: US 2024/0089541 A1
(43) Pub. Date: Mar. 14, 2024

(54) Method, system, and electronic device for controlling audio playback

(71) Applicant: Sunny Distributor Inc., City of Industry, CA (US)

(72) Inventors: Yu Sun, City of Industry, CA (US); Zhaojing Sun, City of Industry, CA (US)

(21) Appl. No.: 17/944,144

(22) Filed: Sep. 13, 2022

(51) Int. Cl. H04N 21/472; H04N 21/439; H04N 21/485

(52) U.S. Cl. CPC H04N 21/47217; H04N 21/4396; H04N 21/4852

(57) ABSTRACT

The present disclosure discloses a method, a system and an electronic device for controlling audio playback. The method includes the steps of: acquiring audio data with dual audio tracks and processing to obtain data of background sound and video sound, and assigning the background sound to a first audio track, and the video sound to a second audio track; providing a volume playback ratio of the first audio track and the second audio track; and playing and displaying according to the volume playback ratio. The present disclosure can adjust the volume ratio of the video sound and the background sound according to the user's desired auditory comfort, realize the volume adjustment of the two sound sources through a single operation, achieve the effect of simplifying the adjustment mode of the volume, and can control only one of the sounds to be played.

### TECHNICAL FIELD

The present disclosure relates to the technical field of audio playback, and in particular, to a method, a system and an electronic device for controlling audio playback.

### BACKGROUND

With the development of mobile Internet technology, mobile video APPs have become indispensable applications in people's lives, such as mobile live broadcast APP, short video APP, movie and TV series APP, etc. The video content played by mobile video APP includes video sound and background sound. For example, in the live broadcast scene, the sound of the anchor playing music or video is the background sound, and the anchor's voice or singing is the video sound; for another example, in the mobile video APP playing movies, TV series, teaching videos, entertainment videos and other scenes, the video content comes with its own background music is the background sound, and the voice of the actor or host is the video sound. At present, the overall video volume can only be adjusted by the volume adjustment button of the mobile phone during video playback, that is, the volume of the video sound and the background sound are controlled at the same time. The user cannot individually adjust the volume of the video sound and background sound, so it cannot meet the user's desired volume adjustment requirements.

### SUMMARY

The present disclosure is intended to provide a method, a system and an electronic device for controlling audio playback, which can adjust the volume ratio of video sound and background sound according to the user's desired auditory comfort level, so as to solve the problem that multiple tracks on the same electronic device can only be adjusted at the same time. The effect of simplifying the adjustment method of the volume can be achieved, and only one sound to be played can be controlled.

In order to achieve the above-mentioned technical objects, the present disclosure adopts the following technical solution:
a method for controlling audio playback, comprising the following steps:
acquiring audio data with dual audio tracks and processing to obtain data of background sound and video sound, and assigning the background sound to a first audio track, and the video sound to a second audio track;
providing a volume playback ratio of the first audio track and the second audio track; and
playing and displaying according to the volume playback ratio.

In an embodiment, the volume playback ratio is a ratio N of volume of the first audio track and the second audio track, N=n1: n2, where each of n1 and n2 is an integer of 0-100, and n1+n2=100.

In an embodiment, step of providing the volume playback ratio of the first audio track and the second audio track is specifically:
providing a slide-controllable equalizer associated with the volume playback ratio of the first audio track and the second audio track; and
adjusting the volume playback ratio by sliding the equalizer.

In an embodiment, step of adjusting the volume playback ratio by sliding the equalizer is specifically:
sliding the equalizer from left to right, to increase the volume of the first audio track and reduce the volume of the second track;
sliding the equalizer from right to left, to increase the volume of the second track and reduce the volume of the first track.

In an embodiment, the equalizer simultaneously displays a percentage value of the volume playback ratio.

In an embodiment, step of acquiring audio data with dual audio tracks and processing to obtain data of background sound and video sound, and assigning the background sound to a first audio track, and the video sound to a second audio track is specifically:
decoding the audio data with the dual audio track, to obtain the data of the background sound and the video sound; and
setting the data of the background sound to be played by the first audio track, and the data of the video sound to be played by the second audio track;
where the first audio track is a left channel, and the second audio track is a right channel.

In order to solve the above technical problem, the present disclosure provides a system for controlling audio playback, comprising:
a data processing unit, configured for acquiring audio data with dual audio tracks and processing to obtain data of the background sound and the video sound, and assigning the background sound to a first audio track, and the video sound to a second audio track;
a volume adjusting unit, configured for providing a volume playback ratio of the first audio track and the second audio track;
a playback control unit, configured for playing and displaying according to the volume playback ratio.

In an embodiment, the volume adjusting unit is a slide-controllable equalizer, the equalizer is associated with the volume playback ratio of the first audio track and the second audio track, the volume playback ratio is adjusted by sliding the equalizer.

In order to solve the above technical problem, the present disclosure provides an electronic device, comprising a memory, a processor, and an application program stored in the memory and executed on the processor, wherein the processor implements the above method for controlling audio playback when executing the application program.

After adopting the above scheme, the present disclosure has the following advantageous effects:
1. Users can adjust the volume ratio of video sound and background sound according to their preferred auditory comfort level to meet the user's need to set different playback volumes for the two types of audios, while solve the problem that multiple audio tracks on the same electronic device can only be adjusted at the same time, such that the effect of simplifying the adjustment method of the volume can be achieved;
2. Through the equalizer, the volume ratio of the two audio tracks can be visually distinguished;
3. It can only play the sound of one of the audio tracks, that is, the effect of playing the video sound or background sound alone.

### BRIEF DESCRIPTION OF DRAWINGS

In order to explain the embodiments of the present disclosure or the technical solutions in the prior art more clearly, the following briefly introduces the accompanying drawings that need to be used in the description of the embodiments or the prior art. Obviously, the accompanying drawings in the following description are only some embodiments of the present disclosure, and for those of ordinary skill in the art, other deformation forms can also be obtained according to these drawings without inventive work.

FIG. 1 is a flowchart of a method for controlling audio playback according to an embodiment of the present disclosure;

FIG. 2 is a schematic diagram of an equalizer associated with a volume playback ratio of a first audio track and a second audio track;

FIGS. 3-5 are the display diagram of the equalizer under different volume playback ratios;

FIG. 6 is a structural block diagram illustrating a system for controlling audio playback according to an embodiment of the present disclosure;

FIG. 7 is a structural block diagram illustrating an electronic device according to an embodiment of the present disclosure.

### DESCRIPTION OF EMBODIMENTS

The technical solutions in the embodiments of the present disclosure will be clearly described below with reference to the accompanying drawings in the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without inventive efforts shall fall within the protection scope of the present disclosure.

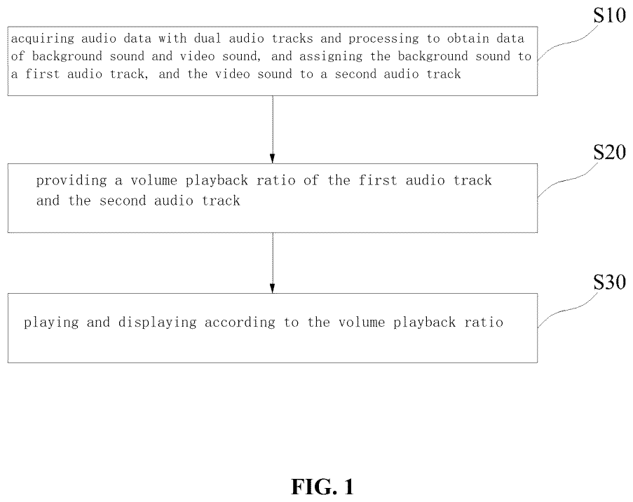

As shown in FIG. 1-FIG. 5, an embodiment of the present disclosure provides a method for controlling audio playback, including the following steps:
S10, acquiring audio data with dual audio tracks and processing to obtain data of background sound and video sound, and assigning the background sound to a first audio track, and the video sound to a second audio track;
S20, providing a volume playback ratio of the first audio track and the second audio track; and
S30, playing and displaying according to the volume playback ratio.

In the present embodiment of the present disclosure, the step of providing the volume playback ratio of the first audio track and the second audio track is specifically: providing a slide-controllable equalizer associated with the volume playback ratio of the first audio track and the second audio track; and adjusting the volume playback ratio by sliding the equalizer. Specifically: sliding the equalizer from left to right, to increase the volume of the first audio track and reduce the volume of the second track; sliding the equalizer from right to left, to increase the volume of the second track and reduce the volume of the first track. Of course, the above-mentioned operation method of adjusting the volume playback ratio by sliding the equalizer is only one of the operation methods. According to user needs, the opposite directions for adjusting can be also provided, or it can be adjusted by sliding up and down. In practice, if the user needs the conditional volume, the equalizer can be accessed by touching the respective video APP button or by pressing the electronic device volume adjustment key, which is convenient for the user to operate.

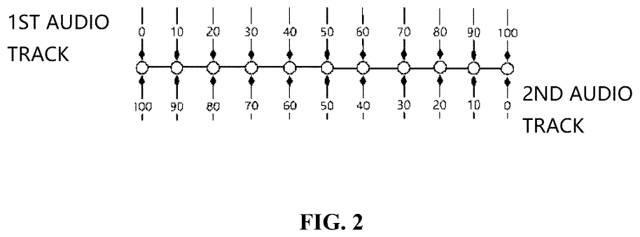

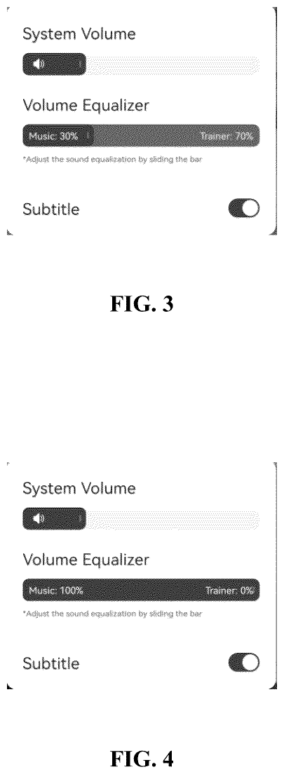

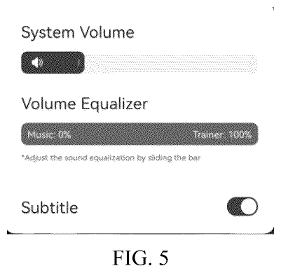

As shown in FIG. 2, the volume playback ratio is the ratio N of the volume of the first audio track and the second audio track, N=n1: n2, where n1 and n2 are integers from 0 to 100, and n1+n2=100. Through the equalizer, the volume ratio of the two audio tracks can be visually distinguished. As shown in FIG. 3, when n1=30, n2=70, the equalizer simultaneously displays the percentage value of the volume playback ratio as the background sound (music) 30% and the video sound (trainer) 70%, and the background sound is greater than the video sound. As shown in FIG. 4, when n1=100, n2=0, the background sound (music) is 100%, and the video sound (trainer) is 0%, and only the background sound is played at this time. As shown in FIG. 5, when n1=0, n2=100, the background sound (music) is 0%, and the video sound (trainer) is 100%, and only the video sound is played at this time.

In the embodiment of the present disclosure, in the above step S10 of acquiring audio data with dual audio tracks and processing to obtain data of background sound and video sound, and assigning the background sound to a first audio track, and the video sound to a second audio track is specifically: decoding the audio data with the dual audio track, to obtain the data of the background sound and the video sound; and
setting the data of the background sound to be played by the first audio track, and the data of the video sound to be played by the second audio track; where the first audio track is a left channel, and the second audio track is a right channel.

In order to solve the above-mentioned technical problems, the present disclosure also adopts the following technical solution:

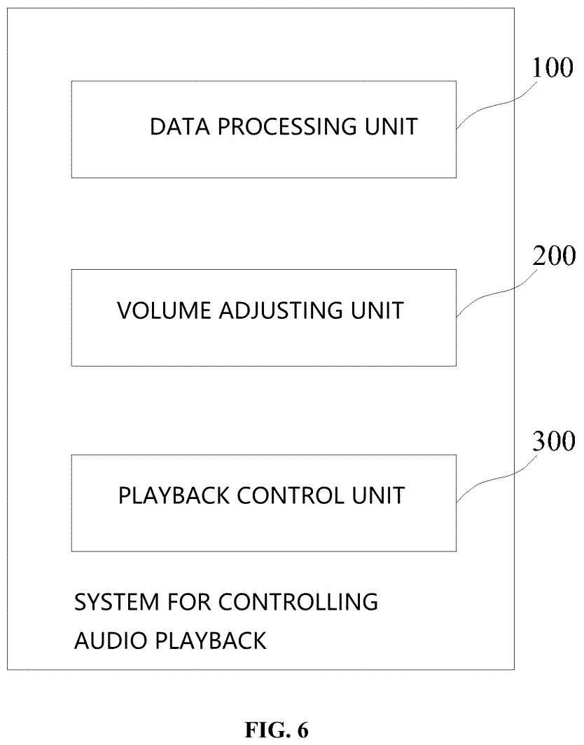

As shown in FIG. 6, a system for controlling audio playback disclosed in the implementation of the present disclosure includes:
a data processing unit 100, configured for acquiring audio data with dual audio tracks and processing to obtain data of the background sound and the video sound, and assigning the background sound to a first audio track, and the video sound to a second audio track;
a volume adjusting unit 200, configured for providing a volume playback ratio of the first audio track and the second audio track;
a playback control unit 300, configured for playing and displaying according to the volume playback ratio.

In the embodiment of the present disclosure, the volume adjusting unit 200 is an equalizer that can be slidably controlled. With reference to FIGS. 2-5, the equalizer is associated with the volume playback ratio of the first audio track and the second audio track. The volume playback ratio is adjusted by sliding the equalizer.

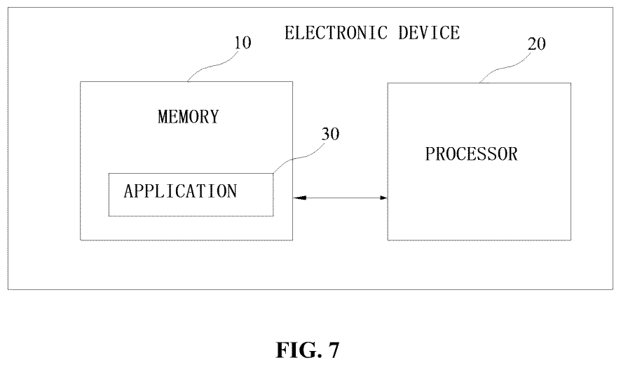

As shown in FIG. 7, an electronic device disclosed in the implementation of the present disclosure includes a memory 10, a processor 20, and an application program 30 stored in the memory 10 and running on the processor 20, where the processor 20 executes the application to implement the above-mentioned method for controlling audio playback. The electronic device may be a terminal device that can store and execute an application program, such as a mobile phone, a tablet computer, a conference tablet, and a notebook computer, etc. The application program is generally an APP that can play videos.

The above technical solutions provided by the embodiments of the present disclosure can satisfy the user's preference for hearing comfort by adjusting the volume ratio of the video sound and the background sound, meeting the user's requirement of setting different playback volumes for the two types of audios. In addition, only one interactive operation is needed to balance the sound volume of the two sound sources at the same time, thereby achieving the effect of simplifying the adjustment method of the volume.

In the description of the specification, reference to description of the terms “one embodiment,” “some embodiments,” “example,” “specific example,” or “an alternative embodiment”, etc. mean that a particular feature, structure, material or characteristic described in connection with the embodiment or example is included in at least one embodiment or example of the present disclosure. In the specification, schematic representations of the above terms do not necessarily refer to the same embodiment or example. Furthermore, the particular features, structures, materials or characteristics described may be combined in any suitable manner in any one or more embodiments or examples.

The above-mentioned embodiments do not constitute a limitation on the protection scope of the technical solution. Any modifications, equivalent replacements and improvements made within the spirit and principles of the above-mentioned embodiments shall be included within the protection scope of the technical solution.

What is claimed is:

1. A method for controlling audio playback, comprising steps of:
acquiring audio data with dual audio tracks and processing to obtain data of background sound and video sound, and assigning the background sound to a first audio track, and the video sound to a second audio track;
providing a volume playback ratio of the first audio track and the second audio track; and
playing and displaying according to the volume playback ratio.

2. The method for controlling audio playback according to claim 1, wherein the volume playback ratio is a ratio N of volume of the first audio track and the second audio track, N=n1: n2, where each of n1 and n2 is an integer of 0-100, and n1+n2=100.

3. The method for controlling audio playback according to claim 1, wherein: step of providing the volume playback ratio of the first audio track and the second audio track is specifically:
providing a slide-controllable equalizer associated with the volume playback ratio of the first audio track and the second audio track; and
adjusting the volume playback ratio by sliding the equalizer.

4. The method for controlling audio playback according to claim 3, wherein step of adjusting the volume playback ratio by sliding the equalizer is specifically:
sliding the equalizer from left to right, to increase the volume of the first audio track and reduce the volume of the second track;
sliding the equalizer from right to left, to increase the volume of the second track and reduce the volume of the first track.

5. The method for controlling audio playback according to claim 3, wherein the equalizer simultaneously displays a percentage value of the volume playback ratio.

6. The method for controlling audio playback according to claim 1, wherein: step of acquiring audio data with dual audio tracks and processing to obtain data of background sound and video sound, and assigning the background sound to a first audio track, and the video sound to a second audio track is specifically:
decoding the audio data with the dual audio track, to obtain the data of the background sound and the video sound; and
setting the data of the background sound to be played by the first audio track, and the data of the video sound to be played by the second audio track;
where the first audio track is a left channel, and the second audio track is a right channel.

7. A system for controlling audio playback, comprising:
a data processing unit, configured for acquiring audio data with dual audio tracks and processing to obtain data of the background sound and the video sound, and assigning the background sound to a first audio track, and the video sound to a second audio track;
a volume adjusting unit, configured for providing a volume playback ratio of the first audio track and the second audio track;
a playback control unit, configured for playing and displaying according to the volume playback ratio.

8. The system for controlling audio playback according to claim 7, wherein the volume adjusting unit is a slide-controllable equalizer, the equalizer is associated with the volume playback ratio of the first audio track and the second audio track, the volume playback ratio is adjusted by sliding the equalizer.

9. An electronic device, comprising a memory, a processor, and an application program stored in the memory and executed on the processor, wherein the processor implements a method for controlling audio playback when executing the application program.
